(19) United States
(12) Patent Application Publication
(10) Pub. No.: US 2026/0140943 A1
(43) Pub. Date: May 21, 2026

(54) Advanced Large Language Model (LLM)-based query builder

(71) Applicant: Zscaler, Inc., San Jose, CA (US)

(72) Inventors: Roi Inbar, Tel-Aviv (IL); Shoham Danino, Tel-Aviv (IL)

(73) Assignee: Zscaler, Inc., San Jose, CA (US)

(21) Appl. No.: 18/950,526

(22) Filed: Nov. 18, 2024

(51) Int. Cl. G06F 16/2452; G06F 16/248

(52) U.S. Cl. CPC G06F 16/24522; G06F 16/248

(57) ABSTRACT

Systems and methods for an advanced query building system include receiving a natural language query from a user, the query including a request for data from one or more data repositories; generating a Structured Query Language (SQL) query based on the natural language query; converting the SQL query to JSON-Logic; and utilizing the JSON-Logic to perform a query, and providing results of the query to the user.

### FIELD OF THE DISCLOSURE

The present disclosure generally relates to network and cloud security. More particularly, the present disclosure relates to systems and methods for an advanced LLM-based query builder.

### BACKGROUND OF THE DISCLOSURE

In the field of enterprise asset security management, it is vital to query large datasets both efficiently and accurately. Traditional query systems present significant challenges because they often require users to have an in-depth knowledge of SQL or other complex query languages. This requirement can obstruct access to essential data and slow down decision-making processes. Given the sensitive nature of the data stored in these systems, robust security and validation measures are critical to prevent unauthorized access and data breaches. However, traditional methods frequently fall short in providing adequate security protocols, leaving data at risk. Based thereon the present invention addresses these challenges by introducing an advanced query builder that translates natural language queries into precise SQL queries.

### BRIEF SUMMARY OF THE DISCLOSURE

The present disclosure relates to systems and methods for an advanced query builder. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include receiving a natural language query from a user, the query including a request for data from one or more data repositories (step 552); generating a Structured Query Language (SQL) query based on the natural language query (step 554); converting the SQL query to JSON-Logic (step 556); and utilizing the JSON-Logic to perform a query, and providing results of the query to the user (step 558).

The steps can further include mapping the one or more data repositories to a prompt for a Large Language Model (LLM). The steps can include, prior to the converting, validating the natural language query, wherein validation is based on any of length, language, prohibited words and expressions, and special characters within the natural language query. Responsive to receiving the natural language query from the user, the steps can include decomposing the natural language query into one or more logical steps, and wherein the SQL query is generated based on the one or more logical steps. The steps can include, responsive to generating the SQL query, validating the SQL query, wherein the validating includes detecting errors and validating compliance with one or more schemas and syntax rules. Responsive to detecting one or more errors, the steps can include informing the user of the one or more errors and allowing the user to provide a new natural language query. The receiving, generating, validating, and converting can each be performed by an LLM agent.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flow diagram representing a plurality of LLM agents adapted to perform advanced query building.

FIG. 6 is a flowchart of a process for an advanced query builder.

### DETAILED DESCRIPTION OF THE DISCLOSURE

Again, the present disclosure relates to systems and methods for an advanced LLM-based query builder. By utilizing Large Language Models (LLMs) and generative AI technologies, the present systems and methods revolutionize data retrieval processes. It features a user-friendly interface that eliminates the need for extensive technical knowledge, thereby enhancing data accessibility. The core functionality of the present invention is rooted in its multi-stage approach, which ensures the accurate and secure transformation of user queries into database queries. The methods described herein handle complex queries effectively while maintaining high standards of data security and validation. By integrating advanced natural language processing capabilities and rigorous security measures, a significant improvement in enterprise asset security management is provided.

### § 1.0 CYBERSECURITY MONITORING AND PROTECTION EXAMPLES

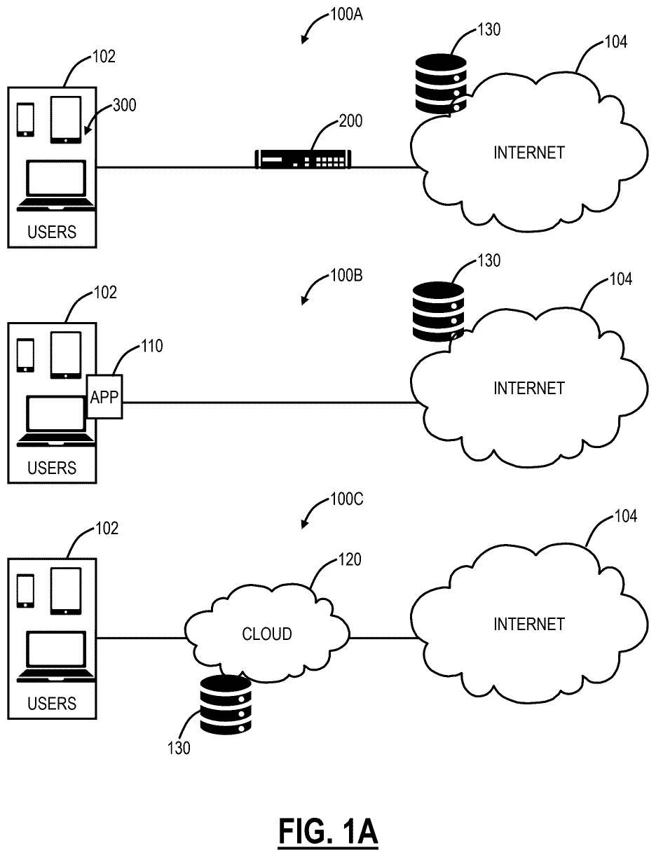

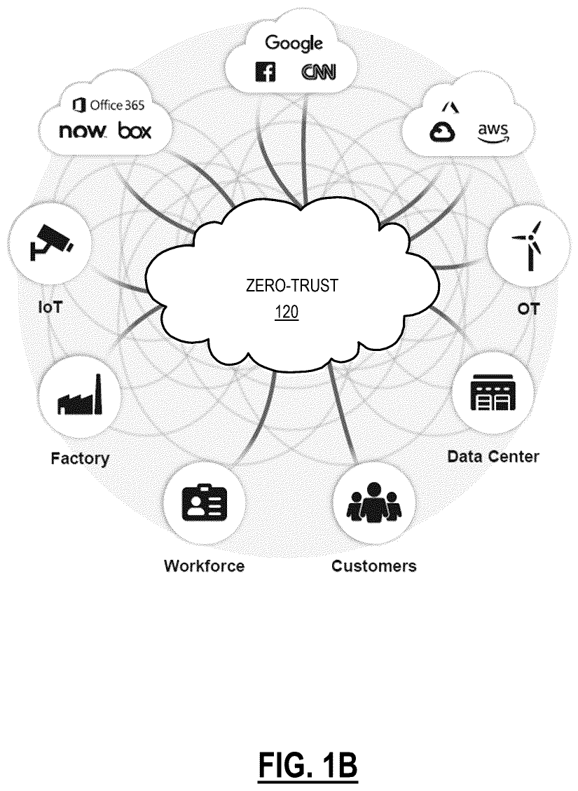

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

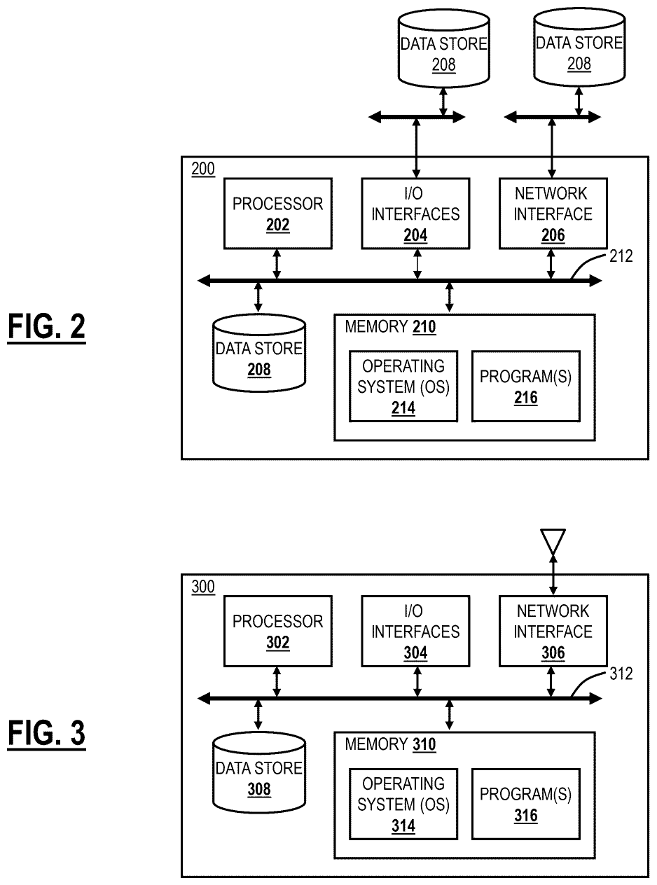

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time-before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 EXAMPLE SERVER ARCHITECTURE

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 EXAMPLE COMPUTING DEVICE ARCHITECTURE

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 APPLICATION FOR TRAFFIC FORWARDING AND MONITORING

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

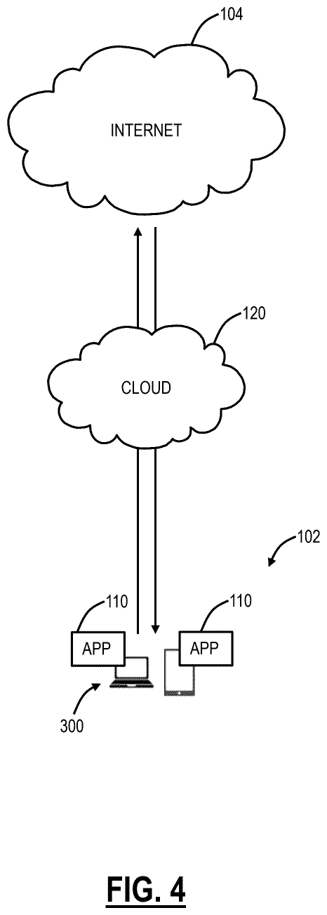

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 ADVANCED QUERY BUILDER

As described, the cloud 120 is adapted to collect and log large amounts of data for its tenants. In the domain of enterprise asset security management, the capability to query extensive datasets/data repositories both efficiently and accurately is paramount. Traditional querying systems often impose significant challenges, as they typically require users to possess an in-depth knowledge of Structured Query Language (SQL) or other intricate query languages. This expertise barrier can hinder access to critical data, thereby limiting an organization's ability to make informed decisions swiftly.

Moreover, the sensitive nature of the data stored within these systems underscores the necessity for robust security and validation measures. Ensuring that data remains protected from unauthorized access and breaches is crucial to maintaining the integrity and confidentiality of enterprise information. These security management products hold comprehensive data about customers' assets, meticulously gathered through multiple scanning processes. Despite this wealth of information, current dashboards do not always display the full spectrum of data available in the database. This gap can lead to inefficiencies and the potential for critical oversight, as users may not have access to all relevant information needed for thorough analysis and decision-making.

To overcome these challenges, there is an increasing demand for an advanced system that enables users to interact with databases in a natural, intuitive, and secure manner. Such a system should facilitate comprehensive access to all pertinent data while maintaining stringent security protocols, ensuring that sensitive information remains protected. By integrating natural language processing capabilities and robust security frameworks, this next-generation solution would empower users to query and retrieve data effortlessly and safely, thereby enhancing efficiency and reducing the risk of data breaches.

Based thereon, the present invention introduces an advanced query builder that leverages the power of Large Language Models (LLMs) and generative AI technologies to interpret and convert natural language queries into precise SQL queries. This system significantly enhances data retrieval processes within enterprise asset security management systems by offering a user-friendly interface, thus eliminating the need for users to have a deep understanding of complex query languages such as SQL.

At the heart of this system is its multi-stage approach, which ensures the accurate and secure transformation of user queries into database queries. This layered methodology not only guarantees the precision of the data retrieval process but also upholds stringent data security measures. By seamlessly translating natural language inputs into structured SQL queries, the system provides a streamlined and efficient means for users to access and analyze critical data. Additionally, the robust security protocols embedded within the system ensure that sensitive information remains protected at all times, mitigating the risk of unauthorized access or data breaches.

Through the integration of advanced AI technologies, the present query builder represents a significant enhancement in the usability and security of enterprise asset security management systems, enabling users to interact with their data in a more intuitive and secure manner.

In various embodiments, the process initiates by mapping the database schema and pertinent metadata into a format that is comprehensible to the LLM. This foundational step involves extracting critical elements such as table names, column names, data types, and the relationships between various tables. That is, the steps can include providing, within the prompt, information about each column, its type, and information regarding relations between tables such as which tables can be joined with which other tables, etc. To enrich this mapping, additional metadata annotations are incorporated, creating a detailed and informative prompt for the LLM. This thorough preparation ensures that the LLM gains a comprehensive and nuanced understanding of the database structure, enabling it to perform accurate and contextually appropriate query translations. By providing the LLM with a rich, annotated representation of the database schema, the system sets the stage for precise and effective natural language to SQL query conversions, ultimately enhancing the efficiency and reliability of data retrieval processes in enterprise asset security management. Below is a simplified example of an example schema that can be converted to a prompt for the LLM.
Table: Assets
Columns: AssetID, Name, Type, OwnerID, Status, CreatedDate

Once the database schema and metadata have been mapped, the system proceeds to validate the natural language queries posed by users. That is, in response to receiving a natural language query from a user via a dashboard, the query including a request for data from one or more data repositories, the system performs a validation process. This validation process is designed to ensure that the queries are clear, unambiguous, and fall within the scope of the database's capabilities. Employing advanced natural language processing (NLP) techniques, the system meticulously interprets the intent and context behind each user's query. By doing so, it can effectively filter out irrelevant or ambiguous requests, ensuring that only meaningful and actionable queries are processed further.

In an example, the validation step can include ensuring clarity, relevance, and prevent ambiguity. Further, the systems can validate the user provided query against the schemas and metadata. An example user provided query can be “What's my total count of assets of type ‘Web’?” Based on the provided query, the systems can also limit the length, validate the language, limit prohibited words and expressions, and limit special characters in order to stop attempts of SQL injection.

This validation step is crucial for maintaining the accuracy and relevance of the data retrieval process. It acts as a safeguard, preventing misinterpretations that could arise from vague or imprecise language. By understanding the user's intent with a high degree of precision, the system can ensure that the subsequent SQL queries generated are not only correct but also highly relevant to the user's needs.

Through this rigorous validation process, the system enhances the overall user experience, making it easier for individuals to interact with complex databases without requiring extensive technical knowledge. This approach not only streamlines the querying process but also upholds the integrity and security of the database by ensuring that only appropriate and well-defined queries are executed.

Following the validation of natural language queries, the system advances to generate what shall be known as a “chain of thoughts” prompt. This innovative approach involves creating a sequence of logical steps that effectively guide the LLM in constructing the correct SQL query. By decomposing the user's query into smaller, manageable sub-queries, the system ensures that each component is addressed systematically.

The “chain of thoughts” prompt works by breaking down the overall query into a series of guiding prompts, each representing a specific step in the logical sequence. This methodical decomposition allows the LLM to process each sub-query individually and in the correct order, ensuring that the context and intent of the original query are preserved throughout the transformation process. By doing so, the system enhances the accuracy and relevance of the SQL query generated.

Utilizing the example query presented above, an example of a “chain of thoughts” prompt can include the following sub-queries.
Identify table: Asset
Determine count operation: COUNT (*)
Apply necessary filters: WHERE Type=“Web”

This step significantly improves the overall precision of data retrieval. By guiding the LLM through a structured and sequential thought process, the system ensures that even complex queries are handled with a high degree of accuracy. Each sub-query is crafted with attention to detail, addressing specific aspects of the user's request and contributing to the formation of a coherent and effective SQL query.

Through this approach, the system not only enhances the LLM's ability to generate precise SQL queries but also reinforces the reliability of the entire data retrieval process. The “chain of thoughts” prompt represents a sophisticated mechanism that bridges the gap between natural language queries and structured database interactions, ensuring that users receive highly accurate and relevant responses to their data inquiries.

With the validated question and the “chain of thoughts” prompt in hand, the system then harnesses the capabilities of the LLM to generate the corresponding SQL query. This crucial stage leverages the LLM's advanced natural language understanding to translate the user's natural language query into a precise and accurate SQL statement.

The process begins by feeding the LLM with the detailed, step-by-step prompts derived from the “chain of thoughts” methodology. This structured guidance ensures that the LLM can comprehensively interpret the user's intent, breaking down the query into its fundamental components and addressing each one systematically. By doing so, the LLM can produce an SQL query that is not only syntactically correct but also contextually aligned with the intricacies of the database schema and metadata.

During this stage, the LLM's capabilities are optimized to enhance both performance and accuracy. The system refines the generated SQL query by ensuring that it is tailored to the specific structure and relationships defined within the database. This contextual refinement is crucial for ensuring that the query retrieves the most relevant data in an efficient manner, minimizing the load on the database and enhancing overall performance.

The LLM is adapted to process the “chain of thoughts” to generate the SQL query. Based on the example prompt and “chain of thoughts” utilized herein, the corresponding SQL query can include the following.
SELECT COUNT (*) AS TotalAssets
FROM Assets WHERE Type=‘Web’;
After generation of the SQL, the system performs validation of the generated SQL to validate SQL syntax and logic.

By leveraging the advanced natural language understanding of the LLM, the system can produce SQL queries that are highly accurate and optimized for performance. This sophisticated approach ensures that the final SQL query is not only effective in retrieving the necessary data but also efficient in terms of execution within the database environment. The integration of validation, logical decomposition, and contextual refinement culminates in a powerful query-building process that bridges the gap between user-friendly natural language input and the precise demands of structured database queries.

In the concluding stage, the generated SQL query is converted into a JavaScript Object Notation (JSON)-Logic representation. This conversion is critical for ensuring that the query adheres to the established data access policies and is secure for execution. By translating the SQL query into JSON-Logic, the system can enforce a higher level of control and compliance, aligning the query execution with organizational policies and security protocols.

Again, using the present example query and generated SQL, the generated JSON-Logic equivalent can include the following.
{
   “data”: “assets”,
   “and”: [
      {
         “op”: “COUNT”,
         “target”: “type”,
         “val”: “Web”
      }
   ]
}

Once the SQL query has been transformed into its JSON-Logic equivalent, it undergoes rigorous syntax validation and policy compliance checks. These checks are essential for verifying that the query is free from errors and conforms to the predefined rules and regulations governing data access. The validation process scrutinizes the syntax to ensure accuracy, while the policy compliance checks confirm that the query does not violate any access controls or security guidelines.

By incorporating these additional layers of validation and compliance, the system guarantees that the final query is both safe and compliant before it is executed against the database. This meticulous approach not only fortifies the security of the data retrieval process but also ensures that users can interact with complex databases without inadvertently breaching data access policies.

In response to a valid JSON-Logic query, the systems are then adapted to run the query and provide results to the user via the dashboard. Again, the dashboard can be contemplated as being associated with the cloud 120. Therefore, a user which is associated with a specific tenant of the cloud 120 will be able to gather data associated with the specific tenant. Again, the data can be any logs, records, etc. collected and stored by the cloud 120.

Overall, this innovative system offers a seamless and secure method for users to interact with intricate databases using natural language. By streamlining the query-building process and embedding robust security measures at every stage, the invention significantly enhances data accessibility, security, and the overall user experience in enterprise asset security management. Users are empowered to retrieve and analyze data efficiently, without needing extensive technical knowledge, while the system ensures that all interactions are conducted within a secure and compliant framework. This holistic approach marks a significant advancement in the field, bridging the gap between user-friendly interfaces and the stringent demands of enterprise-level data security.

More particularly, the present invention offers several key advantages over traditional query systems, transforming the way users interact with and manage enterprise asset security data. These advantages include the following.

User-Friendly Interaction: One of the most notable benefits is the system's user-friendly interface, which allows users to interact with the database using natural language. This eliminates the need for users to have specialized knowledge of SQL or other complex query languages, significantly enhancing the overall user experience and accessibility. Users can now pose queries in plain language, making data retrieval more intuitive and reducing the learning curve associated with traditional database systems.

Increased Efficiency: By automating the query generation process, the system drastically reduces the time and effort required to retrieve data. This automation leads to faster insights and more timely decision-making, thereby improving overall productivity. Users can obtain the information they need quickly and efficiently, freeing up valuable time for other critical tasks.

Enhanced Data Security: The conversion of SQL queries into a JSON-Logic representation ensures that only safe and validated queries are executed. This robust validation mechanism protects sensitive data from unauthorized access and ensures compliance with stringent data governance policies. By incorporating comprehensive security checks at every stage, the system safeguards the integrity and confidentiality of enterprise data.

Scalability: The system is designed to handle a wide range of queries and data schemas, making it highly adaptable to various use cases and industries. Its scalable architecture ensures that it can meet the demands of different organizational needs, whether dealing with small datasets or vast, complex databases. This flexibility makes it suitable for a diverse array of applications, from small businesses to large enterprises.

Accuracy: Leveraging the advanced capabilities of LLMs, the system enhances the accuracy of query results. By understanding and processing complex natural language inputs more effectively than traditional keyword-based search mechanisms, the system delivers more relevant and precise data retrieval. This accuracy ensures that users receive the most pertinent information, enabling more informed decision-making.

Overall, the present systems and methods represent a significant innovation in the field of enterprise asset security management. By providing a secure, efficient, and user-friendly solution for querying extensive datasets, the invention addresses many of the limitations inherent in traditional query systems. It empowers users with greater accessibility to critical data, enhances security protocols, boosts productivity, and delivers accurate results, marking a substantial advancement in how organizations manage and utilize their data.

### § 5.1 Advanced Query Builder Enhancements

The service described herein is designed to transform natural language user questions into precise SQL queries by leveraging LLMs and generative AI technologies. This innovative feature effectively addresses the challenge of enabling non-technical users to interact effortlessly with complex databases, ensuring comprehensive data access and robust security through the use of a JSON-Logic representation of the generated queries.

Traditional approaches to this problem often struggle with iterative validation and refinement of queries, leading to potential inaccuracies and security vulnerabilities. To overcome these limitations, the present optimization introduces a LangGraph framework, a novel enhancement that replaces standard linear chains with a loop-based mechanism. LangGraph incorporates continuous validation of the generated SQL queries, creating a feedback loop where any detected errors are immediately fed back into the node performing the present processes. This iterative process continues until a valid, error-free query is produced.

This iterative validation mechanism significantly enhances the reliability and safety of the system by ensuring that only accurate and secure SQL queries progress to the next stage. By integrating stateful interactions and conditional edge routing for query validation, the LangGraph framework optimizes the service, resulting in more accurate and contextually relevant outcomes.

The integration of the LangGraph framework not only improves the accuracy and contextual relevance of the query results but also maintains stringent data security protocols. The continuous feedback loop ensures that the system can dynamically adapt to errors and refine queries in real time, providing a robust safeguard against potential inaccuracies and security breaches.

Overall, the implementation of the LangGraph framework within this service represents a substantial advancement in the field. It empowers non-technical users to interact with complex databases seamlessly, enhances data accessibility, and upholds high standards of data security. By optimizing the query generation and validation process, the present optimizations ensure that the system delivers reliable, accurate, and secure results, thereby significantly improving the user experience and the overall efficacy of enterprise asset security management.

Furthermore, the LangGraph framework's unique capability to maintain stateful interactions and implement conditional edge routing for query validation significantly enhances the context-awareness and precision of the results. By meticulously keeping track of past interactions, the systems can ensure that the management of complex queries with greater efficacy. This ability to remember and utilize previous interactions allows the system to interpret and respond to user queries in a more nuanced and informed manner, making the entire query generation process more robust and adaptive.

This continuous refinement process not only improves the accuracy of the generated SQL queries but also ensures that the system consistently adheres to stringent data security protocols. Each iteration of the validation loop allows the system to detect and correct errors dynamically, refining the query until it meets the required standards of accuracy and security. This iterative approach acts as a safeguard, preventing potential inaccuracies and ensuring that sensitive information is protected against unauthorized access.

By integrating stateful interactions, the system can comprehend the broader context of user queries, which is especially crucial when handling intricate or multi-faceted questions. This context-awareness leads to more precise and relevant query results, as the system can draw on its memory of previous queries and responses to better understand and fulfill the current request. Additionally, the implementation of conditional edge routing within the LangGraph framework further refines this process by directing the flow of data validation based on specific conditions and criteria. This means that each query is not only validated for correctness but also for compliance with data governance policies and security requirements, adding an extra layer of protection.

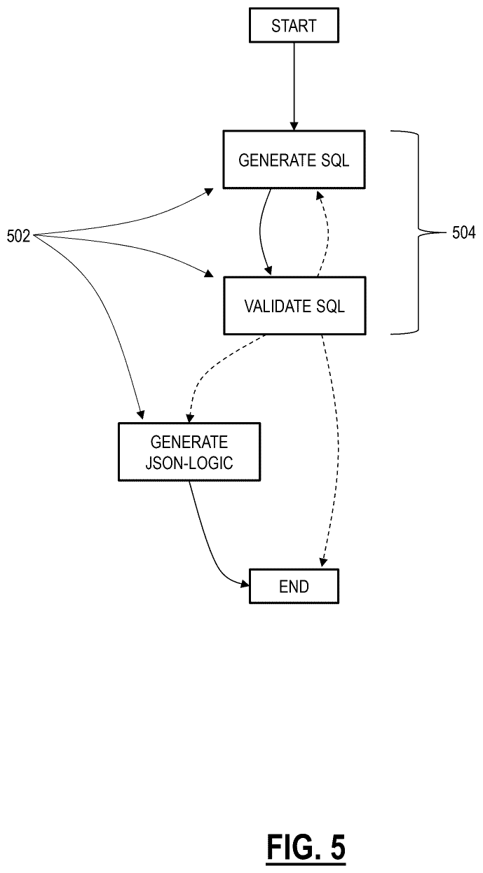

FIG. 5 is a flow diagram representing a plurality of LLM agents. The various agents 502 each have specific tasks which have a call to the LLM. Further, each of the agents 502 can have a relation to one another. By having modular agents 502 for each task, SQL generation, validation, and generating JSON-Logic are separated into distinct nodes. Therefore, tasks are optimized independently for greater control and faster execution. The cyclic validation loop 504 shown can allow the system to automatically correct SQL errors before they propagate further. The system supports parallel execution, allowing nodes/agents 502 to handle multiple queries simultaneously, which enhances performance. Each node is overseen by a specialized agent 502, ensuring that tasks are executed optimally. Additionally, the system is designed for easy extensibility, enabling the addition of new tasks and validation rules without interfering with the existing workflow.

The GenerateSQL node utilizes a language model to produce SQL queries based on user input, optimizing the queries with respect to the database schema. A specialized agent ensures the proper structure and accurate table or column mappings, while real-time feedback facilitates rapid corrections. The ValidateSQL node ensures that SQL queries adhere to schema and syntax rules, detecting errors early and redirecting them to the GenerateSQL node for adjustments. Specialized agents further enhance error handling and validation precision. In the GenerateJSONLogic node, validated SQL is transformed into a secure JSON-Logic format, upholding security policies and compliance requirements. Additionally, the cyclic validation loop 504 activates whenever issues arise, creating a regeneration loop that minimizes debugging time.

In an example, with a user query of “What's my total count of assets of type ‘Web’?”, an output of the GenerateSQL node can include “SELECT COUNT (*) FROM Assets WHERE Type=‘Web’;”. Based thereon, the ValidateSQL node is adapted to perform a plurality of validation checks. These validation checks can include determining if “Assets” is a valid table, if “Type” is a valid column, and if the SQL syntax is valid according to the database dialect. Based on validating the above, the GenerateJSONLogic node will ingest the SQL and produce the converted JSON-Logic. This can include “{“data”: “assets”, “and”: [{“op”: “COUNT”, “target”: “type”, “val”: “Web”}]}”.

Again, looking at FIG. 5, responsive to a user providing a natural language query, the systems are adapted to generate the SQL query and perform validation. In various embodiments, during validation, the system can provide information to the user. That is, the information can include informing the user that the question/query is not valid, request additional information from the user, etc.

The present systems and methods, optimized with the LangGraph framework, offer several key advantages over traditional query systems including the following.

Enhanced Validation: LangGraph's loop mechanism ensures continuous validation of SQL queries until a valid output is achieved. This process significantly enhances the reliability and security of the system by ensuring that only error-free and secure queries are executed. By repeatedly checking and refining queries, the system minimizes the risk of inaccuracies and potential breaches.

Iterative Improvement: The LangGraph framework facilitates iterative refinement, allowing the system to produce more accurate and contextually relevant results. This continuous improvement process ensures that each query is fine-tuned to meet the specific needs of the user, thereby improving the overall quality of data retrieval. The system learns and adapts with each iteration, leading to progressively better performance.

Stateful Interactions: One of LangGraph's standout features is its ability to maintain and reference past states. This capability enables the system to engage in more sophisticated and context-aware interactions, making it particularly effective at handling complex queries. By remembering previous interactions, the system can provide more coherent and logically consistent responses.

Conditional Edge Routing: This feature ensures that only valid and secure SQL queries are executed. By adhering to stringent data access and security protocols, the system safeguards sensitive information and ensures compliance with data governance policies. Conditional edge routing acts as a gatekeeper, allowing only those queries that meet all necessary criteria to proceed.

Overall, the integration of the LangGraph framework into the present systems and methods represents a significant advancement in enterprise asset security management. By combining enhanced validation, iterative improvement, stateful interactions, and stringent security measures, the system offers a secure, efficient, and user-friendly solution for querying extensive datasets. This innovation not only improves data accessibility and accuracy but also ensures that users can interact with complex databases in a seamless and secure manner.

### § 5.2 Advanced Query Builder Process

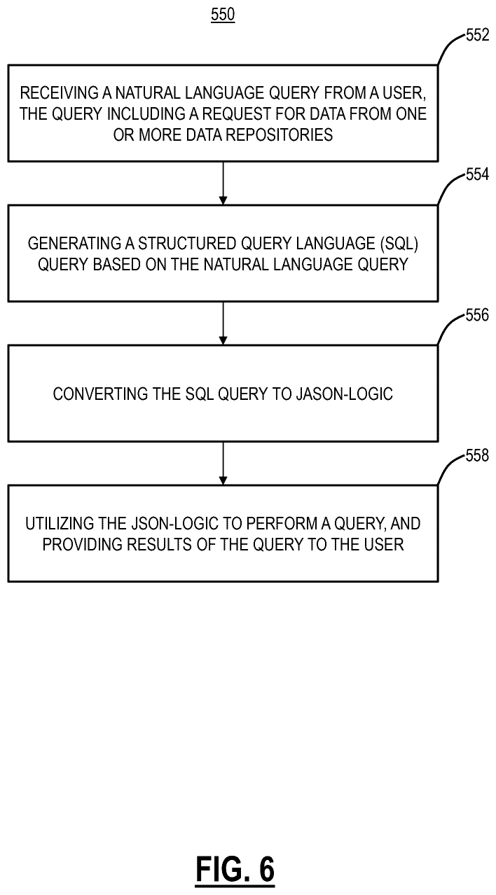

FIG. 6 is a flowchart of a process 550 for an advanced query builder. The process 550 can be contemplated as a method having steps, a processing device configured to implement the steps, a cloud-based system configured to implement the steps, and as a non-transitory computer-readable medium storing instructions for programming one or more processors to execute the steps. The process 550 includes receiving a natural language query from a user, the query including a request for data from one or more data repositories (step 552); generating a Structured Query Language (SQL) query based on the natural language query (step 554); converting the SQL query to JSON-Logic (step 556); and utilizing the JSON-Logic to perform a query, and providing results of the query to the user (step 558).

The process 550 can further include mapping the one or more data repositories to a prompt for a Large Language Model (LLM). The steps can include, prior to the converting, validating the natural language query, wherein validation is based on any of length, language, prohibited words and expressions, and special characters within the natural language query. Responsive to receiving the natural language query from the user, the steps can include decomposing the natural language query into one or more logical steps, and wherein the SQL query is generated based on the one or more logical steps. The steps can include, responsive to generating the SQL query, validating the SQL query, wherein the validating includes detecting errors and validating compliance with one or more schemas and syntax rules. Responsive to detecting one or more errors, the steps can include informing the user of the one or more errors and allowing the user to provide a new natural language query. The receiving, generating, validating, and converting can each be performed by an LLM agent.

### § 6.0 PROCESSING CIRCUITRY AND NON-TRANSITORY COMPUTER-READABLE MEDIUMS

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 7.0 CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner-whether collectively, in subsets, or individually—thereby broadening the range of potential embodiments.

What is claimed is:

1. A method comprising steps of:
receiving a natural language query from a user, the query including a request for data from one or more data repositories;
generating a Structured Query Language (SQL) query based on the natural language query;
converting the SQL query to JSON-Logic; and
utilizing the JSON-Logic to perform a query, and providing results of the query to the user.

2. The method of claim 1, wherein the steps include mapping the one or more data repositories to a prompt for a Large Language Model (LLM).

3. The method of claim 1, wherein the steps include, prior to the converting, validating the natural language query, wherein validation is based on any of length, language, prohibited words and expressions, and special characters within the natural language query.

4. The method of claim 1, wherein responsive to receiving the natural language query from the user, the steps include decomposing the natural language query into one or more logical steps, and wherein the SQL query is generated based on the one or more logical steps.

5. The method of claim 1, wherein the steps include, responsive to generating the SQL query, validating the SQL query, wherein the validating includes detecting errors and validating compliance with one or more schemas and syntax rules.

6. The method of claim 5, wherein responsive to detecting one or more errors, the steps include informing the user of the one or more errors and allowing the user to provide a new natural language query.

7. The method of claim 5, wherein the receiving, generating, validating, and converting are each performed by an LLM agent.

8. A non-transitory computer-readable medium comprising instructions that, when executed, cause one or more processors to perform steps of:
receiving a natural language query from a user, the query including a request for data from one or more data repositories;
generating a Structured Query Language (SQL) query based on the natural language query;
converting the SQL query to JSON-Logic; and
utilizing the JSON-Logic to perform a query, and providing results of the query to the user.

9. The non-transitory computer-readable medium of claim 8, wherein the steps include mapping the one or more data repositories to a prompt for a Large Language Model (LLM).

10. The non-transitory computer-readable medium of claim 8, wherein the steps include, prior to the converting, validating the natural language query, wherein validation is based on any of length, language, prohibited words and expressions, and special characters within the natural language query.

11. The non-transitory computer-readable medium of claim 8, wherein responsive to receiving the natural language query from the user, the steps include decomposing the natural language query into one or more logical steps, and wherein the SQL query is generated based on the one or more logical steps.

12. The non-transitory computer-readable medium of claim 8, wherein the steps include, responsive to generating the SQL query, validating the SQL query, wherein the validating includes detecting errors and validating compliance with one or more schemas and syntax rules.

13. The non-transitory computer-readable medium of claim 12, wherein responsive to detecting one or more errors, the steps include informing the user of the one or more errors and allowing the user to provide a new natural language query.

14. The non-transitory computer-readable medium of claim 12, wherein the receiving, generating, validating, and converting are each performed by an LLM agent.

15. A cloud-based system comprising:
one or more processors; and
memory storing computer-executable instructions that, when executed, cause the one or more processors to:
receive a natural language query from a user, the query including a request for data from one or more data repositories;
generate a Structured Query Language (SQL) query based on the natural language query;
convert the SQL query to JSON-Logic; and
utilize the JSON-Logic to perform a query, and providing results of the query to the user.

16. The cloud-based system of claim 15, wherein the instructions further cause the one or more processors to, prior to the converting, validate the natural language query, wherein validation is based on any of length, language, prohibited words and expressions, and special characters within the natural language query.

17. The cloud-based system of claim 15, wherein responsive to receiving the natural language query from the user, the instructions further cause the one or more processors to decompose the natural language query into one or more logical steps, and wherein the SQL query is generated based on the one or more logical steps.

18. The cloud-based system of claim 15, wherein the instructions further cause the one or more processors to, responsive to generating the SQL query, validate the SQL query, wherein validating includes detecting errors and validating compliance with one or more schemas and syntax rules.

19. The cloud-based system of claim 18, wherein responsive to detecting one or more errors, the instructions further cause the one or more processors to inform the user of the one or more errors and allowing the user to provide a new natural language query.

20. The method of claim 18, wherein the receiving, generating, validating, and converting are each performed by an LLM agent.
